(19) United States
(12) Patent Application Publication
(10) Pub. No.: US 2011/0173536 A1
(43) Pub. Date: Jul. 14, 2011

(54) SYSTEM AND METHOD FOR FACILITATING ON-SITE STAIN REMOVAL

(76) Inventors: MARK ALLAN PAYNE, LAFAYETTE, IN (US); AARON GOODMAN, LAFAYETTE, IN (US)

(21) Appl. No.: 13/004,434

(22) Filed: Jan. 11, 2011

Related U.S. Application Data
(60) Provisional application No. 61/294,260, filed on Jan. 12, 2010.

(51) Int. Cl. G06F 3/048; G06F 7/00

(52) U.S. Cl. 715/716; 707/812; 715/764; 707/E17.044

(57) ABSTRACT

A interactive system for removing stains is provided. The system includes a software program loaded onto an all-in-one touch sensitive display. The program displays step-by-step stain removal instructions and educational information about the stains, fabrics, methods and tools used in the stain removal process. The program can be advanced by the touch of the finger to the screen or the by selecting the auto-play option. The stain removal process is aided by incorporating color labeled bottles of stain removal agents which match color coded text and images displayed in the instructional menus. The user experience is further enhanced by the use of photos and animations depicting fabrics and stains for identification and animations detailing the stain removal process.

### CROSS REFERENCE TO RELATED APPLICATIONS

The present application claims the benefit of U.S. Provisional Patent Application Ser. No. 61/294,260 filed Jan. 12, 2010 entitled “Interactive On Site Stain Removal System and Method of Using” which is hereby incorporated by reference in its entirety to the extent not inconsistent.

### FIELD OF THE INVENTION

The present invention generally relates to a system and method for facilitating the proper and effective removal stains for fabrics and similar materials. More particularly, the present invention pertains to a touchscreen based system which provides instructions for removing an identified stain from a selected fabric type using a set of color-coded stain removal agents.

### BACKGROUND

In the dry cleaning industry, spotting boards became the standard equipment used for stain removal in the early 1940's. Spotting boards are still popular today and are typically used by professionals, such as dry-cleaners, for removing stains in fabrics, such as clothing and outerwear. Spotting boards primarily uses three sources to aid in removing stains. First, a vacuum system can be used to suck or remove agents away from the fabric. Second, steam can be used for flushing a wet agent such as ammonia away from the fabric. Finally, air can be used for drying the fabric after being wetted with water or solvents, for example. There are problems, however, with successfully removing stains. For example, there are many different stains which require certain specific procedures for successful removal from a fabric. In addition, there are many different types of fabrics, and the procedure for removing a stain from one type of fabric may not be the same for one fabric as it is for another. Furthermore, it can be difficult for even a trained operator to remember how a particular stain is removed from a particular fabric.

This presents a problem for those in the stain removal industry as it can be difficult to train and teach new employees how to remove stains from fabrics due to these complexities. Furthermore, mistakes made by combining the wrong stain removal agents or applying the wrong agent to a delicate fabric can ruin or destroy the item. Proper chemistry and procedures have to be used in order to successful remove stains. Most spotting boards do not provide instructions for removing stains, and even if they do, the instructions are often out of date, inaccurate or inconvenient for the operator to follow.

In an effort to alleviate this problem, training schools have developed throughout the country to train operators off-site. However, the knowledge and techniques demonstrated at these schools must be memorized by the student and are often difficult to reference. Most educational information published in books, video training tapes, or visual displays are limited in nature due to availability, the complexities thereof and length for describing the procedures. The operator has to rely on memorization through viewing or reading and then return to the workstation where the spotting board is located to apply the procedures.

Further, hiring someone with little or no experience to follow and learn these procedures requires training and resources before the person becomes experienced in the stain removal procedures. Owners of dry cleaning facilities normally will train some one by using one-on-one or show-and-tell techniques on the job. However, problems arise when the owner or experienced operator is not available for instructions. This can reduce productivity and cause backlog.

Therefore, the need has arisen for an on-site and interactive system that can be used by experienced or inexperienced operators to facilitate the successful removal stains from any type of fabric without lengthy training, voluminous memorization, or advanced chemical knowledge.

### SUMMARY

According to one exemplary embodiment of the present invention, an interactive on-site training tool is provided for assisting with the removal of a stain from a cloth or garment. The method allows the operator to access all the necessary information to remove stains without the need for professional assistance and without leaving the workstation.

Another exemplary embodiment of the present invention includes a system including a touchscreen display for using in displaying procedures for removing selected stain types from selected fabric types, wherein the displayed procedures include reference to stain removal agents and/or tool through color-coded identifying information which corresponded to color-color labels affixed to the stain removal agents and tools.

This summary is provided to introduce a selection of concepts in a simplified form that are described in further detail in the detailed description and drawings contained herein. This Summary is not intended to identify key features or essential features of the claimed subject matter, nor is it intended to be used as an aid in determining the scope of the claimed subject matter. Yet other forms, embodiments, objects, advantages, benefits, features, and aspects of the present invention will become apparent from the detailed description and drawings contained herein.

### BRIEF DESCRIPTION OF THE DRAWINGS

FIG. 1 is a perspective of one form of the present invention configured for use and installed on a spotting board.

FIG. 2 is a plan view of one set of stain removal agents provided in conjunction with one form of the present invention.

FIG. 3 is a plan view of one set of the labels provided in conjunction with another form of the present invention which are suitable for application to the container of stain removal agents to be utilized.

FIG. 4 is a diagrammatic view of a computer system suitable for implementing one form of the present invention.

FIG. 5 is a flowchart illustrating the various tracks implemented in one form of the Stain Removal Application according to one form of the present invention.

FIG. 6 is a screen shot of a representative home screen displayed by the Stain Removal Application according to one form of the present invention.

FIG. 7 is a screen shot of a representative stain removal screen displayed by the Stain Removal Application according to one form of the present invention.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

In a dry-cleaning facility or other stain-removal setting, a number of different personnel are tasked with removing stains. This requires that each posses the skills and knowledge necessary to successfully remove various stains for the many different types of fabrics commonly encountered both quickly and without damaging the fabric. The present disclosure, through reference to the accompanying figures, describes a system and associated method for removing stains that provides color-coded stain removal agents along with an interactive reference for ascertaining and carrying out the proper stain removal procedure.

The system and method for facilitating proper stain removal described herein shall be illustrated as implemented via computer software and hardware, with appropriate components and devices.

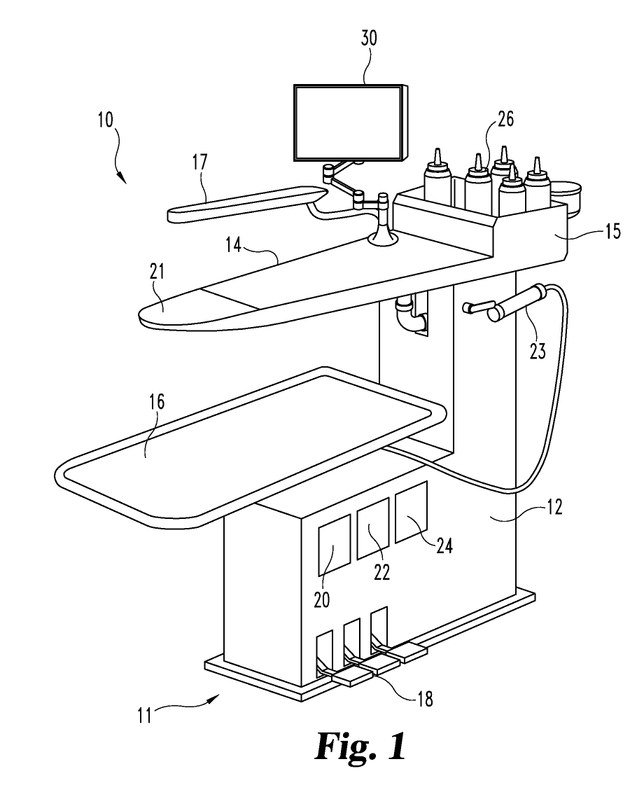

FIG. 1 is a perspective of one form of the present invention configured for use and installed on a spotting board. The illustrated system 10 includes a spotting board 11. Spotting board 11 is a traditional spotting board common in the art, and it shall be appreciated that other types of spotting boards, spotting cabinets, or the like having a different shape, size, and/or configuration may be utilized in combination with the present invention. Spotting board 11 includes a base 12, upper platform 14, and a lower platform 16. Upper platform 14 is typically a large, flat workspace constructed primarily of a smooth water-resistant material such as stainless steel, glass, or the like. As illustrated, upper platform 14 may be in the form of a traditional ironing board to enable a variety of different garment types to be laid flat, such as a sleeve board. In this form, upper platform 14 also includes a stain-removal agent storage bin 15 where stain-removal-agents may be stored for subsequent use during the current task. Similarly, lower tray 16 is also a large, flat workspace, but it is often constructed from a metal frame covered with a selected fabric. In addition, lower platform 16 often takes on a different shape from upper platform 14 to provide versatility. Furthermore, a sleeve board 17 is provided above or adjacent to upper platform 16. Sleeve board 17 is typically of a similar construction to upper platform 16, but having a smaller size and shape adapted for use when removing stains from the sleeves of garments.

Base 12 typically includes user controls, such as foot pedals 18, which enable the user to operate steam 20, vacuum 22, and air 24 which all have corresponding sources contained within or connected to base 12. Steam source 20 generates steam which may also be emitted from the spotting gun 23 for use in working stains from a fabric. Vacuum source 22 generates a suction force within vacuum zone 21 of upper platform 14 for use in removing agents from a fabric. Finally, air source 24 generates a stream of compressed air of the like which is emitted from the spotting gun 23 for use in working stains from a fabric. It shall be appreciated that the illustrated steam, vacuum, and air sources may be connections to external steam, vacuum, and air sources or generators. Additionally, alternate controls may be utilized for controlling the use of vacuum source 20, air source 22, and steam generator 24.

Exemplary spotting boards, such as the one illustrated in FIG. 1, include the “Model 44SP” and “Model 44SPG” spotting boards provided by FORENTA L. P. of 2300 W. Andrew Johnson Hwy #A, Morristown, Tenn. 37814. It shall be appreciated that other spotting boards manufactured by FORENTA or other suppliers would be suitable for use with the system and method described herein. Furthermore, it shall be appreciate that the present invention may be utilized independent of a specialize spotting board.

According to the illustrated form, system 10 also includes a display 30 mounted in a position so as to be before a user standing at spotting board 11 and within convenient reach of the user. Display 30 is connected to or includes an integrated computer (not shown) for purposes of presenting an interactive stain removal application to the user and, in the event display 30 is a touchscreen, receiving the user's input. Turning to the details of display 30, the display, in this form, is a flat panel monitor, such as an LCD panel, OLED panel, plasma display, surface-conduction electron-emitter display, or the like. However, in alternate forms, display 30 may be any other type of display, including a CRT monitor or the like. In the illustrated form, display 30 is a touch screen display, such as a capacitive or resistive touch screen. Furthermore, the display 30 is preferably between approximately 6″ and 24″ in size when measured diagonally across its visible screen. In a more preferred form, display 30 is between approximately 8″ and 15″ in size. For purposes of non-limiting example, display 30 may be a model KTLC-12W-USB/B touch screen monitor supplied by KEYTEC, INC. of 520 Shepherd Drive, Garland, Tex. 75042, USA. It shall be appreciated that other monitors manufactured by KEYTEC or other suppliers would be suitable for use with the system and method described herein.

Additionally, system 10, as shown in FIG. 1, includes a set of stain removal agents 26 (partially illustrated). These agents are utilized to ease the stain removal process by chemically modifying the stain or otherwise affecting the stain to enable proper removal. Common stain removal agents include acids, alkalis, oils, solvents, digesting agents, acids, detergents, and bleaches, just to name a few representative examples. Often times, more than one specific type of each stain removal agent is included. Furthermore, two different stain removal agents often have complex scientific names which can be easily mistaken for one another, such as perchloroethylene and trichloroethylene, leading to undesired results.

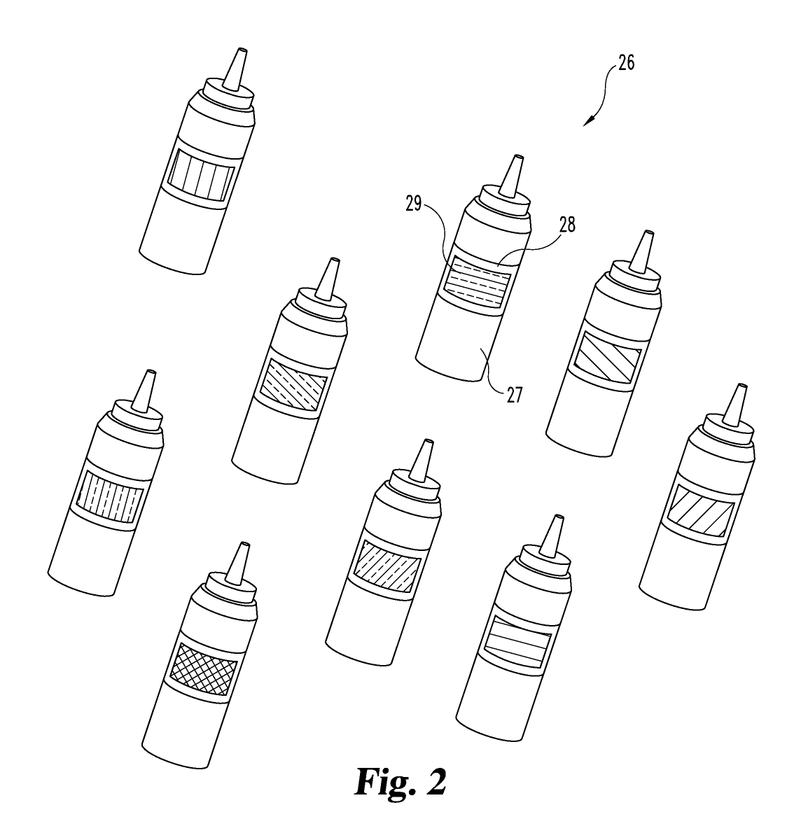

Turning to FIG. 2, one form of the set of stain removal agents 26 provided in conjunction with the display 30 and stain removal application is illustrated. The stain removal agents 26, according to this form, are provided in bottles 27, such as plastic squeeze bottles, having a selected tip or top, for applying the agent to the fabric. Each bottle 27 includes a unique label 28 which includes identifying indicia 29. According to the form illustrated, the identifying indicia 29 may be a color code, which may comprise a coloring of the entire label, a portion of the label, an image, the text, the chemical name, or any combination of these or the like, wherein the color is then associated with a selected stain removal agent or stain removal agent type. In alternate form, readily identifiable shapes or other quickly identifiable indicia may be utilized. It shall be appreciated that any color coded bottle, dispenser, or applicator may be utilized without departing from the spirit of the invention. For example, refillable plastic squeeze bottles may be provided, with each bottle a label identifying a selected stain removal agent. These bottles 27 may be provided empty or full of the selected agent.

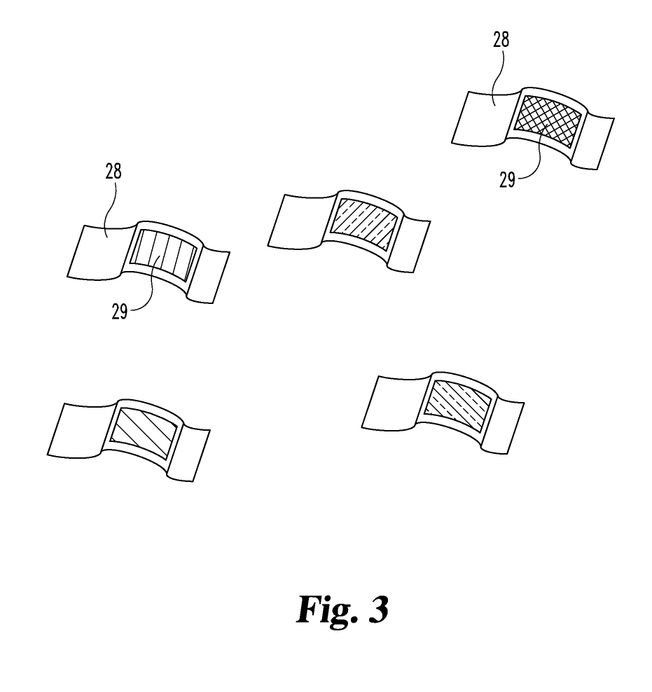

Alternatively, as illustrated in FIG. 3, the set of stain removal agents 26 (not shown in FIG. 3) for use with the display 30 and stain removal application may be separately provided, such as by the user of a third-party vendor. In this form, the system 10 includes a series of labels 28 which are suitable for attachment to a stain removal agent bottle, dispenser, applicator, or the like. Each label 28 similarly includes identifying indicia 29 so that, when affixed to an agent container, they enable a user to readily identify the stain removal agent contained therein according to its identifying indicia 29. As above, the identifying indicia 29 may be a color coding, such as a colored image, text, or any combination of the like. For example, various stain removal agents of the same class (i.e. bleaches, detergents, etc.) may each have a color code which is a shade of a selected color, which stain removal agents from differing classes having color codes of differing colors altogether. In alternate form, shapes or other quickly identifiable indicia may be utilized. In addition, for purposes of re-filling the stain removal agents' bottles, the labels may also included mixing instructions, as stain removal agents are often sold in concentrated form and must be mixed prior to use. Furthermore, the labels may also included other information, such as safety, legal, or proper disposal information, as required or desired.

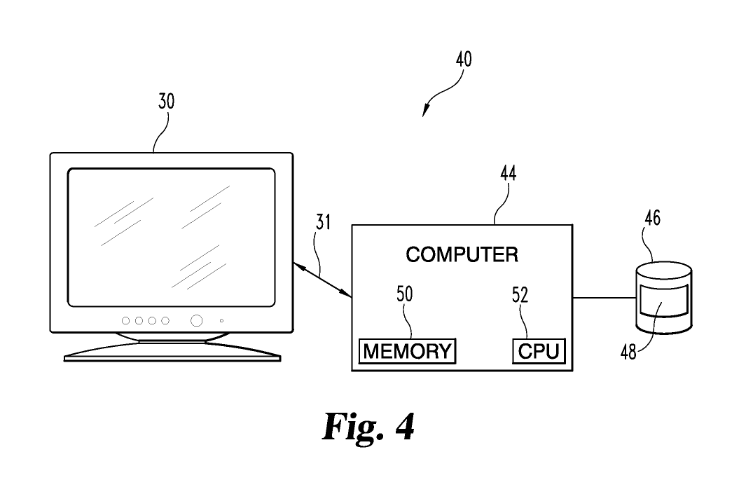

FIG. 4 is a diagrammatic view of computer system 40 of one embodiment of the present invention. Computer system 40 includes a server of personal computer, namely computer 44. computer 44 is preferably connected to or includes a data store 46 which stores business logic for a Stain Removal Application 48, such as stain removal processes, stain removal agent information, and demonstrative graphics and videos/animations. System 40 also includes display 30, which is connected to and driven by computer 44 through operative connection 31, which may be any combination of HDMI, DVI, DSUB, USB, or the like. While display 30 is illustrated as being a touch screen display powered by a client computer, it should be understood that display 30 may also be in the form of a handheld device, simple display connected to a video source, thin client, tablet computer, or the like. In addition, computer 44 or display 30 may include one or more speakers (not shown) for presenting associated audio to the user generated by Stain Removal Application 48. Furthermore, it should be understood that while only a single computer and display are illustrated, more or fewer may be utilized in alternative embodiments. For example, in a multi-station implementation, system 40 might include one or more displays driven by one or more computers 44.

In the illustrated embodiment, computer 44 of system 40 includes one or more types of memory 50 and one or more processors or CPUs 52. Memory 50 preferably includes a removable memory device. Processor 52 may be comprised of one or more components configured as a single unit. Alternatively, when of a multi-component form, processors 52 may have one or more components located remotely relative to the others. One or more components of each processor 52 may be of the electronic variety defining digital circuitry, analog circuitry, or both. In one embodiment, each processor 2 is of a conventional, integrated circuit microprocessor arrangement, such as one or more CORE™ processors (including CORE 2 Duo, Core i3, Core i7 and the like) or PENTIUM 4® processors supplied by INTEL Corporation of 2200 Mission College Boulevard, Santa Clara, Calif. 95052, USA. It shall be appreciated that other processors manufactured by INTEL or other suppliers would be suitable for use with the system and method described herein.

Memory 50 (removable or generic) is one form of a computer-readable device. Memory may include one or more types of solid-state electronic memory, magnetic memory, or optical memory, just to name a few. By way of non-limiting example, memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disc memory (such as a DVD or CD ROM); a magnetically encoded hard disc, floppy disc, tape, or cartridge media; or a combination of any of these memory types. Also, memory 50 may be volatile, nonvolatile, or a hybrid combination of volatile and nonvolatile varieties.

While data store 46 is shown as connected to computer 44, it shall be appreciated that data store 46 can reside in the same or different location(s) and/or be incorporated within computer 44. For example, data store 46 can reside within memory 50 of computer 44. As one non-limiting example, data store 46 can exist all or in part either in a database or in one or more files within a computer readable medium that is operatively connected to computer 44, such as via a network, through an Internet connection, or otherwise. Alternate arrangements may be included which shall be appreciated by those of skill in the computer arts.

Turning collectively to FIGS. 1-4, a user may utilize the system 10 of FIG. 1 to perform traditional stain removal methods absent any pre-existing knowledge. The computer 44 and interactive touch screen display 30 which are running and displaying the Stain Removal Application 48 guide the operator through each step to remove a stain at the workstation. As will be described in detail below, the operator may view a video/animated presentation, written and/or audible step-by-step instructions for each stain removal method which is customized to the user-specified stain and fabric types.

As described above with respect to FIGS. 2 and 3, all stain removing agents are labeled with identifying indicia, which in this form shall be described as a color coding, along with a content description for the operator to identify. For example, during the presentation the instructions will be for the operator to use the bottle labeled in red for removing blood and another bottle with corresponding indicia for bleaching if necessary.

The touch screen method is an interactive software based program designed to eliminate errors in stain removal. The requirement for massive memorization of methods and chemicals is no longer required because the procedures are programmed for the operator. Owners and management can now be absent for the workstation and inexperienced operators can perform any stain removal process without supervision. The system guides the operator during each step of the process to successfully remove any stain from any fabric without leaving the workstation.

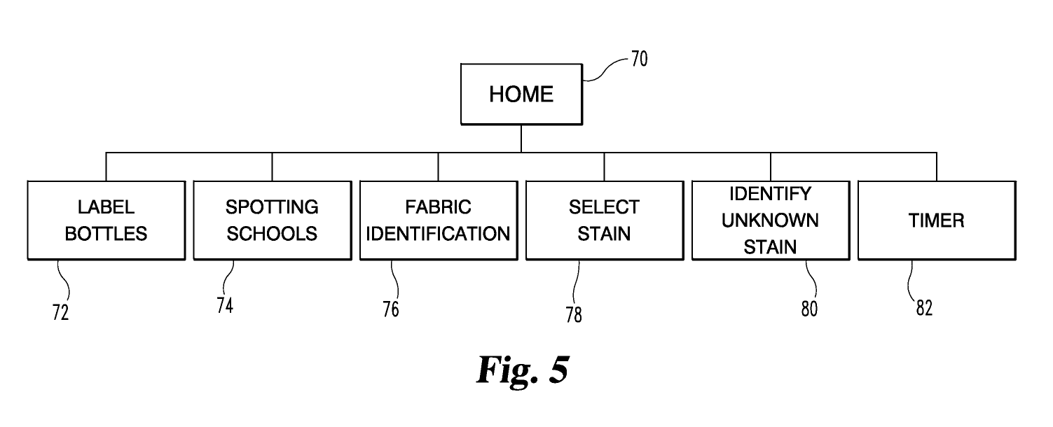

Turning to FIG. 5, a flowchart illustrating the various navigational tracks provided in one form of Stain Removal Application 48 are illustrated. According to the organizational form illustrated, these tracks all individually originate from and return to home screen 70, but it shall be appreciated that they may be otherwise ordered in series depending upon the desires of the user. The navigational tracks include: Label Bottles 72, Spotting Schools 74, Fabric Identification 76, Select Stain 78, and Identify Unknown Stain 80. The Label Bottles track 72 guides the user through the procedures for properly labeling the bottles of stain removal agents with the labels provided with system 10, according to the form shown in FIG. 3. In some forms where the system 10 includes pre-labeled agents, this track may be omitted. The Spotting School track 74 provides education information about the agents, tools, and techniques utilized in the stain removal processes suggested in other tracks. Fabric Identification track 76 provides visual and descriptive guidance which will assist a user in properly selecting the fabric type for the garments they are working upon. Select Stain track 78 is the principal focus of Stain Removal Application 48 and guides the user through the process for successfully removing a stain of the selected type, based upon a number of criteria, such as the type of fabric the stain is to be removed from. The Identify Unknown Stain Track 80 assists a user in identifying the type of stain they are working upon, if needed, as in order to obtain the best results the inputs must be as accurate as possible. Finally, the Timer track 82 is always available allowing the user to initiate a timer, which may be used as part of a routine stain removal process or utilized in conjunction with any other track shown in FIG. 5. Furthermore, the timer functionality may be embedded within the other tracks of accessible in the other tracks, as will be further illustrated below.

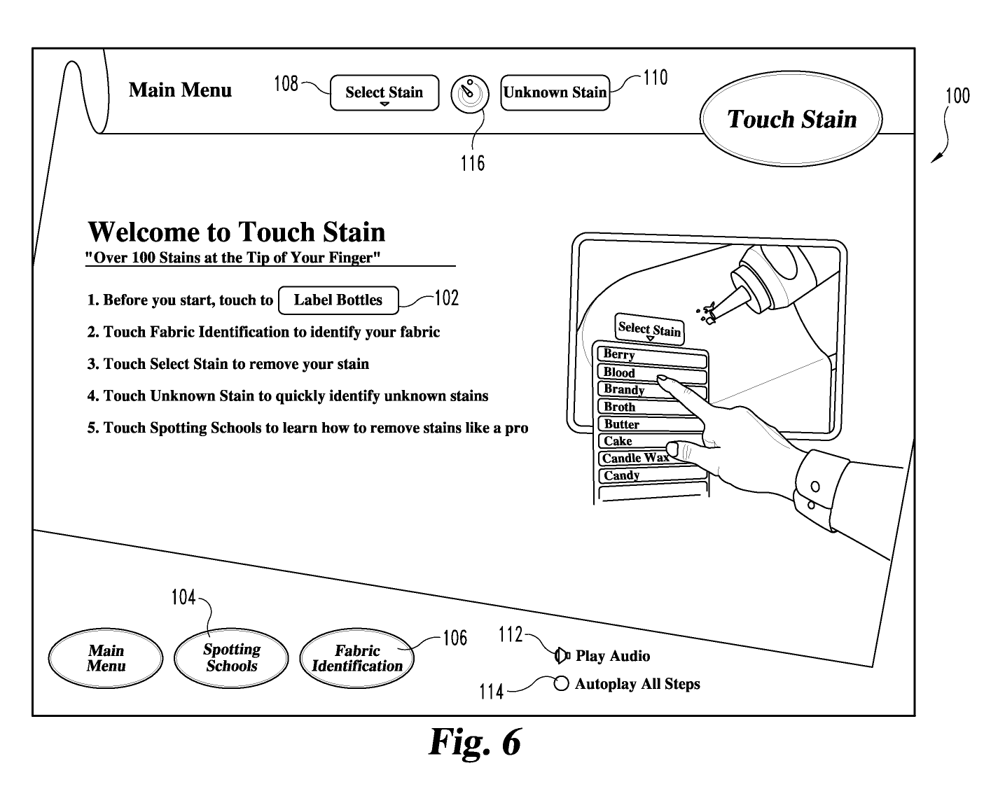

FIG. 6. is a representative home screen 100 displayed by the Stain Removal Application 48 on display 30 according to one illustrated form. From the home screen 100, the user may selected one of the many tracks described above. According to this form, the application 48 provides for a series of buttons 102, 104, 106, 108, and 110 which the user may select to launch the above described track Label Bottles 72, Spotting Schools 74, Fabric Identification 76, Select Stain 78, and Identify Unknown Stain 80 respectively. Home screen 100 also includes additional options, such as audio and sequence advancing controls 112 and 114 which enable the user to turn sound on or off as well as control whether or not the various screens automatically advance based on timing or must be manually advanced. Home screen 100 also includes a manually configurable general purpose timer for use in stain removal processing or the like.

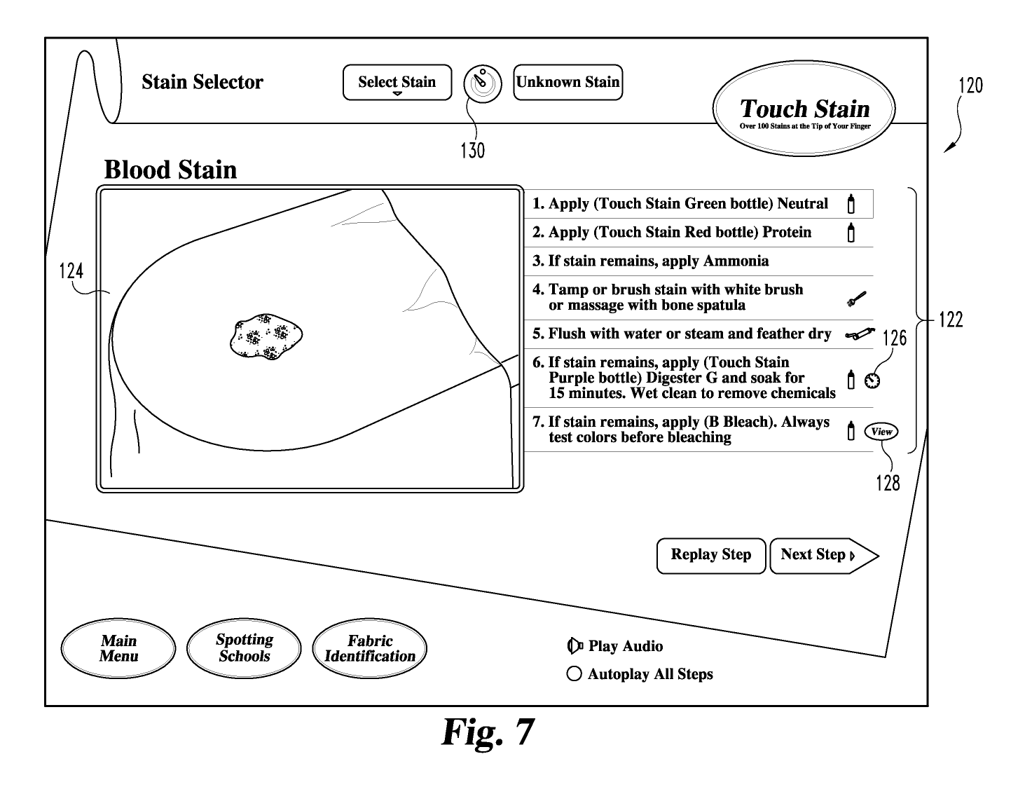

Turning to FIG. 7, a representative stain removal screen 120 which may be displayed by the Stain Removal Application 48 on display 30 according to one illustrated form. For purposes of illustration, stain removal screen 120 would be displayed in response to a user selecting “Blood” as the stain type using button 108 of FIG. 6. The user may select the type of stain from a list of stains categorized alphabetically. The user may click on the letter “B” for information about how to remove a blood stain. Again, the program can go through a step-by-step description for what chemicals and equipment are necessary for removing the stain. The user may also be given the option, if necessary, to select the type of fabric the stain is in. In a further form, the program may also coordinate with an attached or attached scanner that is capable of identifying the type of stain in a fabric if this information is unknown and returning it to the program for use in selecting a stain removal process.

Screen 120 includes a multi-step stain removal procedure 122, which is provided to the user is several discrete steps in sequential order. In addition, the steps which involve the use of a stain removal agent are accompanied by reference to the identifying indicia (e.g. color coding) which are similarly included on the label which is attached to the corresponding stain removal agent bottle. In addition to the written procedure, the Stain Removal Application 48 may provide a video/animated demonstration 124 with one or more steps in the procedure 122. Also, audio will also be available for users who wish to have the step by step instructions read to them. Furthermore, next to each step in the stain removal procedure 122 in which timing is critical, the Stain Removal Application 48 may provide a timer 126, which, when selected by the user, begins a countdown which coincides with the recommended treatment time in that step. For instance, if a step calls for soaking the stained area for 15 minutes, the user would immediately be presented with a pre-set timer for 15 minutes. In further form, the user would be able to adjust the timer before starting it in accordance with their preferences.

As the user progresses through the stain removal procedure 122, the user may select the next step. Upon doing so, a new series of animation will appear to illustrate the current process until the process is complete and the stain is removed. Alternatively, the steps may automatically advance based upon pre-programmed time estimated to complete the task, which serves to reduce the level of user input required. Furthermore, alongside each written step of the process, an icon, such as icon 128 will be available for the operator to select. The icons will allow the operator to view a specific chemical or video/animated presentation for a specific step. Additionally, screen 120 includes an additional timer button 130 which is typically accessible from any screen in the Stain Removal

While only the representative example of removing a blood stain is provided in the include figures, numerous additional examples of the procedures for use in removing various stains from various fabric types is provided in Appendix A. Representative type of stains are Adhesive Tape, Albumin, Animal Stain, Apple Stain, Asparagus, Asphalt (Road Tar), Automobile Wax, Avocado, Banana, Beer, Beets, Berry Stains, Blood, Brandy, Broths, Butter, Cakes, Candle Wax, Candy, Carbon Paper, Cat Urine, Catsup, Caviar, Cheese or Sauce, Chewing Gum, Chlorine, Chocolate, Cider, Clam Chowder, Coffee, Cola Beverage, Color Changes, Cooking Oil, Cough Syrup, Crayons, Deodorants—Underarm, Dog Urine, Egg, Eye Drops, Flowers, Foods, Fruits, Furniture Wax or Polish, Gasoline, Gin and Tonic, Ginger Ale, Glue—Super, Glue—Elmer, Glue—Rubber, Grape Juice, Grass Stains, Gravy, Grease Spots, Greases, Guacamole, Gutter or Road Salt, Hair Dressing, Hair Dyes, Hand Lotions, Holiday Sauce, Ice Cream, Ink—Ball Point, Ink d Blue/Black, Ink—Red, Jam or Jelly, Ketchup, Kool Aid®, Leather Stains, Lemon Aid, Lipstick, Liquor Drinks, Makeup, Milk Shake, Mascara, Meat Sauces, Medicine, Metallic Stains, Mildew, Milk, Milk Shake, Mouth Washes, Mud, Mustard, Nail Polish, Oil Spots, Oils—Motor, Olive Oil, Orange Juice, Oyster/Clam Chowder, Paints—

Acrylic, Paints—Latex, Pea Soup, Peanut Butter, Perfumes, Perspiration Stains, Pizza, Plastics, Polish—Shoe, Potatoes or Yams, Ravioli, Rice, Rouge, Rust, Salad Dressings, Saliva, Salsa, Scorch, Shellac, Sherbert—Ice Cream, Shoe Polish, Smoke Odors, Soft Drinks, Soot—Fire, Sour Cream, Soy Milk, Soy Sauce, Spaghetti, Spotting or Sizing Rings, Sugar Carmelized, Syrups, Tabasco Sauce, Tar—Road, Tar—Roof, Tea, Tobacco or Chew, Tomato Sauce, Tooth Paste, Turkey Gravy, Urine—Human, Varnish, Venison—Deer Meat, Vomit, Watercolors, Water Rings, Wines, Wood Stains, and Yogurt. Procedures for removing a subset of these stains are provided.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the invention as described herein and/or by the following claims are desired to be protected.

For example, a person of ordinary skill in the computer software art will recognize that the client and/or server arrangements, user interface and display content, and/or data layouts as described in the examples discussed herein could be organized differently on one or more computers to include fewer or additional options or features than as portrayed in the examples and still be within the spirit of the invention.

What is claimed is:

1. A system for facilitating the proper removal of stains from fabrics comprising:
a plurality of color coded labels, wherein each label includes a color code;
a computer storing a stain removal application;
a database operatively connected to said computer, said database storing a plurality of stain removal processes, wherein each stain removal process is associated with at least one stain type and includes instructions for the application of at least one stain removal agent, and an association between at least one stain removal agent and at least one color code;
a touch screen video display operatively connected to said computer for displaying said stain removal application wherein said stain removal application includes a user interface; and
wherein said computer is responsive to input provided to said user interface by a user through said touch screen video display to display at least a portion of a stain removal process selected from said plurality of stain removal processes and reference at least one stain removal agent utilized in said stain removal process by at least its associated color code.

2. The system of claim 1, wherein said plurality of color coded labels each include the name of a selected stain removal agent.

3. The system of claim 2, wherein an association is stored in said database between the color code of each label in said plurality of color coded labels and the name of a selected stain removal agent on said label.

4. The system of claim 3, wherein said color code includes a coloring of said name of selected stain removal agent.

5. The system of claim 1, wherein said color code includes a solid coloring of at least 25% of the area of said label.

6. The system of claim 1, wherein each stain removal agent within a selected class of stain removal agents is associated in said database with a color code having a unique selected shade of a single selected color.

7. The system of claim 5, wherein said selected type of stain removal agents is selected from the group consisting of: detergents, acids, alkalis, and oxidizing solvents.

8. The system of claim 1, wherein said touch screen video display is between 5″ and 12″.

9. The system of claim 1 further comprising:
a plurality of bottles, wherein each of said plurality of color coded labels is affixed to or integrated in one of said plurality of bottles.

10. The system of claim 1, wherein said touch screen video display is mounted to a spotting board.

11. The system of claim 1, wherein said database stores at least one animation in association with a selected stain removal process, wherein said animation demonstrates how to perform at least one step of said selected stain removal process and is configured for display on said touch screen display by said computer.

12. The system of claim 1, wherein said database stores at least one voice file in association with a selected stain removal process, wherein said voice file describes at least one step of said selected stain removal process and is configured to be played aloud by said computer.

13. The system of claim 1, wherein each of said plurality of color coded labels is a solid colored label.

14. A method of operating a touch screen computer to facilitate the proper removal of stains from fabrics, the touch screen computer executing an application, comprising:
providing a touch screen display, comprising a plurality of virtual graphical user interface (GUI) items;
storing a plurality of stain removal processes in a database accessible by said touch screen computer, wherein each stain removal process is associated with at least one stain type and includes instructions for the application of at least one stain removal agent, and an association between at least one stain removal agent and at least one color code;
detecting that a user has touched the touch screen to nominally activate at least one virtual GUI item indicating a type of stain;
processing said type of stain to select an appropriate stain removal process from said plurality of stain removal processes; and
display said appropriate stain removal on said touch screen display, wherein said stain appropriate removal process is displayed such that at least one stain removal agent utilized in said stain removal process is identified by an associated color code.

15. The method of claim 14, further comprising the step of:
labeling a plurality of containers of stain removal agents with color coded labels; and
storing an association in said database between the stain removal agents and the color codes contained on said color coded labels.

16. The method of claim 14 further comprising the step of:
detecting that a user has touched the touch screen to nominally activate at least one virtual GUI item indicating a type of fabric prior to said processing step; and
utilizing said type of fabric in said processing step to select the appropriate stain removal process from said plurality of stain removal processes.

17. The method of claim 14, further comprising the step of:
displaying an electronically stored animation on said touch screen display which demonstrates how to perform at least one step in said appropriate stain removal process.

18. The method of claim 14, further comprising the step of:
playing an electronically stored audio file using said touch screen computer which describes at least one step in said appropriate stain removal process.

19. A non-transitory computer program product, comprising a computer usable medium having a computer readable program code embodied therein, said computer readable program code adapted to be executed to control a touch screen based computer to implement a method for facilitating the proper removal of stains from fabrics comprising:
storing a plurality of stain removal processes in a database accessible by said touch screen computer, wherein each stain removal process is associated with at least one stain type and includes instructions for the application of at least one stain removal agent, and an association between at least one stain removal agent and at least one color code;
detecting that a user has touched the touch screen to nominally activate at least one virtual GUI item indicating a type of stain;
processing said type of stain to select an appropriate stain removal process from said plurality of stain removal processes; and
displaying said appropriate stain removal process on said touch screen display, wherein said appropriate stain removal process is displayed such that at least one stain removal agent utilized in said stain removal process is identified by an associated color code.

20. The computer program product of claim 19, wherein said computer readable program code is further adapted to be executed to perform the following steps:
detecting that a user has touched the touch screen to nominally activate at least one virtual GUI item indicating a type of fabric prior to said processing step; and
utilizing said type of fabric in said processing step to select the appropriate stain removal process from said plurality of stain removal processes.
